(19) United States
(12) Patent Application Publication
(10) Pub. No.: US 2024/0004539 A1
(43) Pub. Date: Jan. 4, 2024

(54) INFORMATION PROCESSING DEVICE AND INFORMATION PROCESSING PROGRAM

(71) Applicant: FUJIFILM CORPORATION, Minato-ku, Tokyo (JP)

(72) Inventors: Masanori SATAKE, Kanagawa (JP); Tetsuya WATANABE, Kanagawa (JP); Yui HIROYA, Kanagawa (JP)

(21) Appl. No.: 18/253,401

(22) PCT Filed: Dec. 1, 2021
(86) PCT No.: PCT/JP2021/044146

§ 371 Date: May 18, 2023

(30) Foreign Application Priority Data
Dec. 2, 2020 (JP) 2020-200492

(51) Int. Cl. G06F 3/04847; G06F 3/0488; G06F 3/0482

(52) U.S. Cl. CPC G06F 3/04847; G06F 3/0488; G06F 3/0482

(57) ABSTRACT

The image forming device is provided with a CPU. An image forming device includes a central processing device (CPU). The CPU, when a movement operation is performed by a user on an operation unit that performs a display unit, and a trajectory of the movement operation reaches the outside of an instruction unit including a movable area of the operation unit, moves the operation unit to follow a movement operation in the inside of the movable area; when the movement operation is completed in the inside of the instruction unit after the operation unit moves into an execution area from a starting area through the movement operation, executes a predetermined operation; and when the movement operation is completed in the outside of the instruction unit after the operation unit moves into the execution area from the starting area through the movement operation, stops the predetermined operation.

### TECHNICAL FIELD

The technology of the present disclosure relates to an information processing device and an information processing program.

### BACKGROUND ART

For example, Japanese Patent Application Laid-Open (JP-A) No. 2018-51222 describes an information processing device including a user interface that executes various processes on a game medium. The information processing device includes: a display unit that displays a game medium; an operation unit that receives a first input operation of selecting the game medium by a user and a second input operation of instructing a process on the game medium selected by the first input operation, and outputs first input operation data in which the first input operation is associated with coordinate information and second input operation data in which the second input operation is associated with coordinate information; a storage unit that stores information in which the process on the game medium is associated with a direction; and a control unit. The control unit specifies the selected game medium based on the first input operation data, acquires information from the storage unit, specifies the direction from a start point to an end point of the second input operation based on the second input operation data, and executes a process at a position associated with the direction from the start point to the end point of the second input operation in the information on the selected game medium.

### SUMMARY OF INVENTION

### Technical Problem

Meanwhile, in a user interface (UI) screen of a touch panel system, a slide start function using a touch button may be mounted as an instruction unit that gives an instruction to execute an operation.

In this instruction unit, when a user executes a movement operation such as dragging or sliding on the operation unit and the operation unit moves beyond the start area into the execution area, a predetermined operation is executed.

An object of the present disclosure is to provide an information processing device and an information processing program capable of preventing execution of an unintended operation in a case in which an operation unit reaches an execution area by a movement operation by a user and the movement operation is completed outside of an instruction unit including a movable area of the operation unit.

### Solution to Problem

In order to achieve the above object, according to a first aspect, an information processing device includes a processor in which, in a case in which a user performs a movement operation on an operation unit displayed on a display unit, and a trajectory of the movement operation reaches outside of an instruction unit including a movable area that is an area where the operation unit is movable, the processor causes the operation unit to move into the movable area and follow the movement operation. In a case in which the movement operation is completed inside the instruction unit after the operation unit is moved by the movement operation from a start area which is an area included in the movable area and in which a predetermined operation is not executed into an execution area which is an area where the predetermined operation is executed, the processor executes the predetermined operation. In a case in which the movement operation is completed outside of the instruction unit after the operation unit is moved from the start area into the execution area by the movement operation, the processor stops executing the predetermined operation.

An information processing device according to a second aspect may be the information processing device according to the first aspect in which the processor executes the predetermined operation in a case in which the movement operation is completed inside the instruction unit and a position of the operation unit when the movement operation is completed inside the instruction unit is within the execution area after the trajectory of the movement operation reaches outside of the instruction unit.

An information processing device according to a third aspect may be the information processing device according to the first or second aspect in which the processor stops executing the predetermined operation in a case in which the movement operation is completed inside the instruction unit and the position of the operation unit when the movement operation is completed inside the instruction unit is within the start area after the trajectory of the movement operation reaches outside of the instruction unit.

An information processing device according to a fourth aspect may be the information processing device according to any one of the first to third aspects in which in a case in which the movement operation is completed outside of the instruction unit after the operation unit is moved from the start area into the execution area by the movement operation, instead of stopping executing the predetermined operation, the processor moves the operation unit from the start area into the execution area by the movement operation and then completes the movement operation outside of the instruction unit. In a case in which an end point of the trajectory of the movement operation when the movement operation is completed outside is included in an area located in a movement direction of the operation unit in the movable area, the processor executes the predetermined operation and completes the movement operation outside of the instruction unit after the operation unit is moved from the start area into the execution area by the movement operation. In a case in which the end point of the trajectory of the movement operation when the movement operation is completed outside is not included in the area located in the movement direction of the operation unit in the movable area, the processor stops executing the predetermined operation.

An information processing device according to a fifth aspect may be the information processing device according to any one of the first to fourth aspects in which the processor performs control such that notification that the execution of the predetermined operation has stopped is executed when the trajectory of the movement operation reaches outside of the instruction unit after the operation unit is moved from the start area into the execution area by the movement operation.

An information processing device according to a sixth aspect may be the information processing device according to the fifth aspect in which a background color of the movable area is different between a case in which the operation unit is located inside the start area and a case in which the operation unit is located inside the execution area, and
wherein, in a case in which the trajectory of the movement operation reaches outside of the instruction unit after the operation unit is moved from the start area into the execution area by the movement operation, the processor executes control such that the background color of the movable area is identical to a background color in a case in which the operation unit is located in the start area.

In order to achieve the above object, an information processing program according to a seventh aspect causes a computer to execute: causing an operation unit to move into a movable area and follow a movement operation in a case in which a user performs the movement operation on the operation unit which is displayed on a display unit, and a trajectory of the movement operation reaches outside of an instruction unit including a movable area that is an area where the operation unit is movable; executing a predetermined operation in a case in which the movement operation is completed inside the instruction unit after the operation unit is moved by the movement operation from a start area which is an area included in the movable area and in which the predetermined operation is not executed into an execution area which is an area where the predetermined operation is executed; and stopping executing the predetermined operation in a case in which the movement operation is completed outside of the instruction unit after the operation unit is moved from the start area into the execution area by the movement operation.

### Advantageous Effects of Invention

According to the first and seventh aspects, there is an advantageous effect that execution of an unintended operation can be prevented in a case in which the operation unit reaches the execution area by the movement operation by the user and the movement operation is completed outside of the instruction unit including the movable area of the operation unit.

According to the second aspect, there is an advantageous effect that a predetermined operation can be executed in a case in which the movement operation is completed inside the instruction unit after the trajectory of the movement operation reaches outside of the instruction unit.

According to the third aspect, there is an advantageous effect that even in a case in which the movement operation is completed inside the instruction unit after the trajectory of the movement operation reaches outside of the instruction unit, the execution of the predetermined operation can be stopped.

According to the fourth aspect, there is an advantageous effect that the predetermined operation can be executed even in a case in which the end point of the trajectory of the movement operation by the user is moved over from the execution area in order for the user to execute the predetermined operation.

According to the fifth aspect, there is an advantageous effect that, in a case in which the trajectory of the movement operation by the user reaches outside of the instruction unit, the user can ascertain that it is notified that the execution of the predetermined operation is stopped.

According to the sixth aspect, there is an advantageous effect that, in a case in which the trajectory of the movement operation by the user reaches outside of the instruction unit, the user can ascertain that the execution of the predetermined operation is stopped by changing the background color of the movable area.

### BRIEF DESCRIPTION OF DRAWINGS

FIG. 1 is a block diagram illustrating an example of an electrical configuration of an image forming device according to a first embodiment.

FIG. 2 is a block diagram illustrating an example of a functional configuration of the image forming device according to the first embodiment.

FIG. 3 is a diagram illustrating an example of a screen displayed on a display unit by a process of a CPU.

FIG. 4 is a diagram illustrating an example of a movable area determined in advance for an instruction unit.

FIG. 5 is a schematic diagram illustrating an example of a relationship between a user operation and a position of a slide mark with respect to the user operation in the instruction unit displayed on a display unit.

FIG. 6 is a diagram illustrating a first operation execution process according to the first embodiment.

FIG. 7 is a diagram illustrating a first operation stopping process according to the first embodiment.

FIG. 8 is a flowchart illustrating an example of a flow of a process by the information processing program according to the first embodiment.

FIG. 9 is a diagram illustrating a second operation execution process according to a second embodiment.

FIG. 10 is a diagram illustrating a second operation stopping process according to the second embodiment.

FIG. 11 is a diagram illustrating an example of a peripheral area of an instruction unit according to a third embodiment.

FIG. 12 is a diagram illustrating a first notification process according to a fourth embodiment.

FIG. 13 is a diagram illustrating a second notification process according to a fifth embodiment.

### DESCRIPTION OF EMBODIMENTS

Hereinafter, an example of a mode for carrying out the technology of the disclosure will be described in detail with reference to the drawings. The same reference numerals are given to constituent elements and processes in which the operation, operational effects, and functions have the same functions throughout the drawings, and repeated description may be omitted as appropriate. Each drawing is only schematically illustrated to the extent that the technology of the disclosure can be sufficiently understood. Therefore, the technology of the disclosure is not limited only to the illustrated examples. In the embodiment, description of configurations that are not directly related to the invention and known configurations may be omitted.

In the embodiment, an example of an information processing device that executes a predetermined operation on an operation unit such as a mark displayed on a display unit such as a display by a user manual operation (hereinafter referred to as a user operation) on the operation unit will be described.

In the disclosure, the “operation unit” is a concept including an image displayed on a display unit such as a display. The “movement operation” is a concept including a change in an instruction position by a user operation during sequential movement. Examples of the movement operation include a user operation of moving during a touch on a display unit such as a display, for example, dragging in which a touch operation by a user continues between a start point and an end point, and a user operation such as sliding. Examples of the “start of the movement operation” include a user operation by start of a touch on a display unit such as a display, as start of an instruction by the user. Examples of the “completion of the movement operation” include a user operation by touch releasing, as end of the instruction by the user. The “predetermined operation” is a concept including a predetermined instruction (command) executed by the processor and information indicating the instruction. Examples of the predetermined operation include a process executed by a processor itself or another processor. The “execution of an operation” is a concept including an output of a predetermined instruction (command) executed by a processor and an output of information indicating the instruction. The “stop of execution of an operation” is a concept including stop of the output of the predetermined instruction (command) executed by the processor and stop of the output of the information indicating the instruction.

### First Embodiment

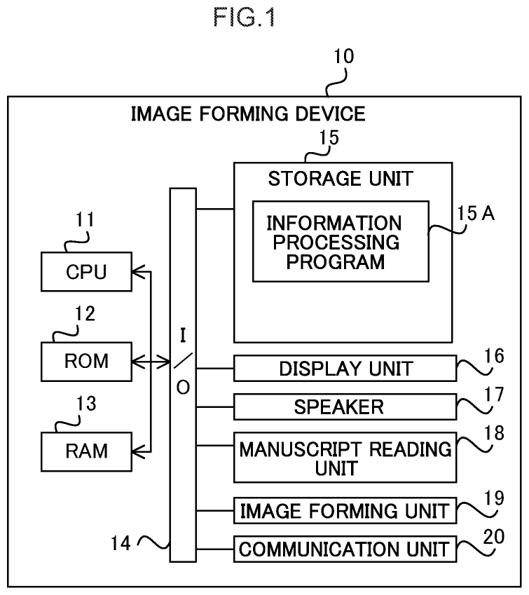

FIG. 1 is a block diagram illustrating an example of an electrical configuration of an image forming device 10 according to a first embodiment.

As illustrated in FIG. 1, the image forming device 10 according to the present embodiment includes a central processing unit (CPU) 11, a read-only memory (ROM) 12, a random access memory (RAM) 13, an input/output interface (I/O) 14, a storage unit 15, a display unit 16, a speaker 17, a document reading unit 18, an image forming unit 19, and a communication unit 20.

The image forming device 10 is an example of an information processing device. In addition to the image forming device 10, the information processing device according to the present embodiment is considered to be a general information processing device such as a smartphone, a tablet terminal, or a game device that has a UI screen in which a touch panel system is adopted, for example.

Each unit of the CPU 11, the ROM 12, the RAM 13, and the I/O 14 is connected via a bus. Functional units including the storage unit 15, the display unit 16, the speaker 17, the document reading unit 18, the image forming unit 19, and the communication unit 20 are connected to the I/O 14. These functional units can communicate with the CPU 11 via the I/O 14.

The CPU 11, the ROM 12, the RAM 13, and the I/O 14 configure a control unit. The control unit may be configured as a sub-control unit that controls some of operations of the image forming device 10 or may be configured as a part of a main control unit that controls operations of entire the image forming device 10. For some or all of the blocks of the control unit, for example, an integrated circuit such as a large scale integration (LSI) or an integrated circuit (IC) chip set is used. An individual circuit may be used for each of the blocks, or a circuit in which some or all of the blocks are integrated may be used. The blocks may be provided integrally each other, or some of the blocks may be provided separately. Some of the blocks may be provided separately. The integration of the control unit is not limited to an LSI, and a dedicated circuit or a general-purpose processor may be used.

As the storage unit 15, for example, a hard disk drive (HDD), a solid state drive (SSD), a flash memory, or the like is used. The storage unit 15 stores an information processing program 15A according to the present embodiment. The information processing program 15A may be stored in the ROM 12.

For example, the information processing program 15A may be installed in advance in the image forming device 10. The information processing program 15A may be implemented by being stored in a nonvolatile storage medium or distributed via a network and appropriately installed in the image forming device 10. As an example of the nonvolatile storage medium, a compact disc read only memory (CD-ROM), a magneto-optical disk, an HDD, a digital versatile disc read only memory (DVD-ROM), a flash memory, a memory card, or the like is assumed.

As the display unit 16, for example, a liquid crystal display (LCD), an organic electro luminescence (EL) display, or the like is used. The display unit 16 integrally includes a touch panel, and receives various input operations by the user via the touch panel. For the touch panel, for example, a capacitive touch system is adopted. For the touch panel, a method other than the capacitive touch system may be adopted. The speaker 17 outputs a preset sound effect sound or the like in accordance with various input operations.

The document reading unit 18 captures documents one by one placed on a sheet feeding table of an automatic document feeder (not illustrated) provided in an upper portion of the image forming device 10, and optically reads the captured documents to obtain image information. Alternatively, the document reading unit 18 optically reads a document placed on a document table such as a platen glass to obtain image information.

The image forming unit 19 forms an image which is based on image information obtained through reading by the document reading unit 18 or image information obtained from an external personal computer (PC) or the like connected via a network on a recording medium such as paper. In the embodiment, an electrophotographic system will be described as an example of a system of forming an image, but another system such as an inkjet system may be adopted.

In a case in which the system of forming an image is an electrophotographic method, the image forming unit 19 includes a photosensitive drum, a charging unit, an exposure unit, a developing unit, a transfer unit, and a fixing unit. The charging unit applies a voltage to the photosensitive drum to charge the surface of the photosensitive drum. The exposure unit forms an electrostatic latent image on the photosensitive drum by exposing the photosensitive drum charged by the charging unit with light in accordance with image information. The developing unit forms a toner image on the photosensitive drum by developing the electrostatic latent image formed on the photosensitive drum with toner. The transfer unit transfers the toner image formed on the photosensitive drum to a recording medium. The fixing unit fixes the toner image transferred to the recording medium through heating and pressing.

The communication unit 20 is connected to a network such as the Internet, a local area network (LAN), or a wide area network (WAN), and can communicate with an external PC or the like via the network.

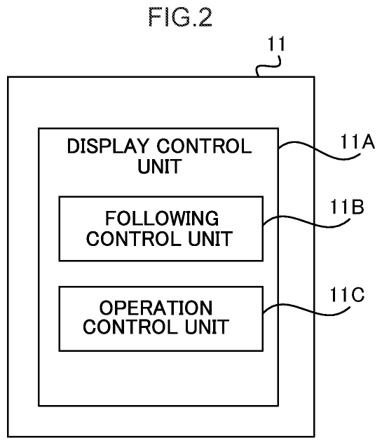

The CPU 11 of the image forming device 10 according to the present embodiment functions as each unit illustrated in FIG. 2 by writing and executing the information processing program 15A stored in the storage unit 15 in the RAM 13.

FIG. 2 is a block diagram illustrating an example of a functional configuration of the image forming device 10 according to the first embodiment.

As illustrated in FIG. 2, the CPU 11 of the image forming device 10 according to the present embodiment functions as a display control unit 11A. The display control unit 11A includes a following control unit 11B and an operation control unit 11C.

The display control unit 11A has a control function of controlling display of an image on the display unit 16 and a control function of controlling execution of an operation and stop of the execution of the operation in accordance with a display position of an operation unit displayed as an image on the display unit 16.

The following control unit 11B executes control such that an image is displayed on the display unit 16 and executes control such that an operation unit displayed as an image to follow a movement operation by the user is displayed. That is, when the user executes a movement operation on the operation unit while displaying the operation unit on the display unit 16, the following control unit 11B displays the operation unit at a position on the display unit 16 followed by the movement operation.

When the movement operation of the operation unit displayed to follow the movement operation by the user is completed, the operation control unit 11C controls non-execution or execution of the operation corresponding to the position of the operation unit. The non-execution of the operation is control for maintaining a state (for example, an initial state) in which the execution of the operation is not started by a movement operation which does not lead to the execution of the operation. The control of the execution of the operation includes control for executing a predetermined operation or control for stopping the execution of the predetermined operation.

Next, execution of an operation by the CPU 11 of the image forming device 10 according to the embodiment will be described. In the following description, execution of document copying will be described as an example of execution of an operation by the CPU 11. The execution of the operation is not limited to the execution of copying of the document and may be another process executed in the image forming device 10.

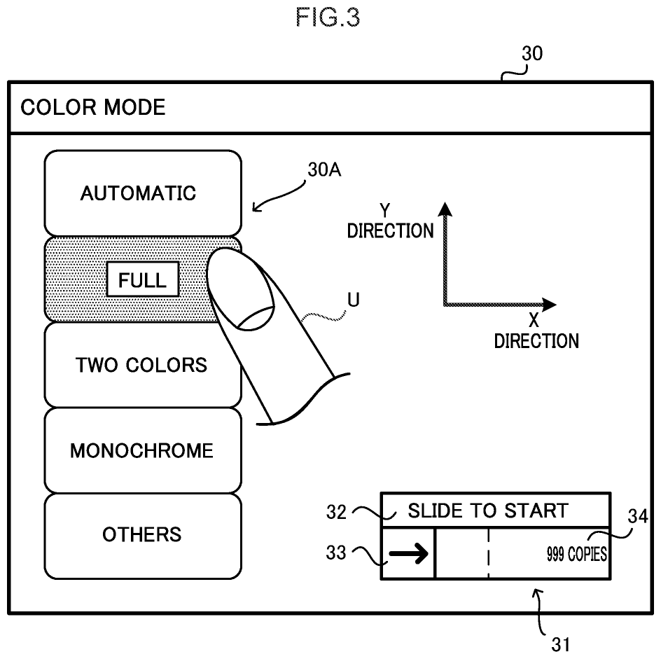

FIG. 3 is a diagram illustrating an example of a screen 30 displayed on the display unit 16 by the process of the CPU 11.

FIG. 3 illustrates an example of a setting screen on which a setting regarding color is executed when a document is copied by exemplifying a copying condition in an image copying function among document-related functions executed by the CPU 11. In the following description, a horizontal rightward direction and a vertical upward direction of the screen when the user views the screen are referred to as X and Y directions, respectively.

In the example of the screen 30, a selection instruction button 30A for instructing setting of a copying condition regarding a color when a document is copied is displayed. The copying condition is a setting of a function of the image forming device 10 that can be set in a case in which a copying target is copied (for example, a document), and the function is set as a parameter. In the example illustrated in FIG. 3, selection instruction buttons for giving an instruction for a setting related to any color of “auto”, “full”, “two colors”, “monochrome”, and “others” are displayed. The “auto” button of the selection instruction button is a button for automatically detecting a color of a document and giving an instruction to select copying with a color in the document. The “full” button is a button for selecting and instructing copying of a document in multiple colors included in the image forming device 10. The “two colors” button is a button for selecting and giving an instruction for copying in two predetermined colors. The “monochrome” button is a button for selecting and giving an instruction for copying with a predetermined single color. The “others” button is a button for selecting and giving an instruction for copying by setting other colors. Since parameters of the copying conditions are a known technique, the description thereof will be omitted.

FIG. 3 illustrates a screen on which the “full” button is reversely displayed when the “full” button is pressed by the user operation as a state in which the setting of the copying condition is instructed.

On the screen 30 illustrated in FIG. 3, when a copying condition is instructed, an image is displayed in the instruction unit 31 for giving an instruction to execute copying. The instruction unit 31 includes a message area 32 for displaying a message, a slide mark 33 indicating a movable image for giving an instruction to execute copying, and a display area 34 for displaying the number of copies among the copying conditions. In the message area 32, a message indicating a user operation in a case in which execution of copying is instructed is displayed. In the example illustrated in FIG. 3, a message “slide to start” indicating that copying is executed (that is, started) by moving (that is, sliding) the slide mark 33 is displayed. The slide mark 33 can also be displayed at a position moved in the X direction (and the opposite direction). The slide mark 33 is an example of the operation unit.

In the example of FIG. 3, the message area 32 is an area where an explanation of the operation method is displayed, and the display content does not change. When the slide mark 33 is brought into contact with a finger of the user U, the color changes, and a movement operation such as dragging or sliding becomes enabled. In the display area 34, information which depends on a function (for example, a copy function, a print function, a facsimile function, a scanner function, and the like) of the image forming device 10, such as the number of copies and the number of transmissions, is displayed. The instruction unit 31 need not to include the message area 32.

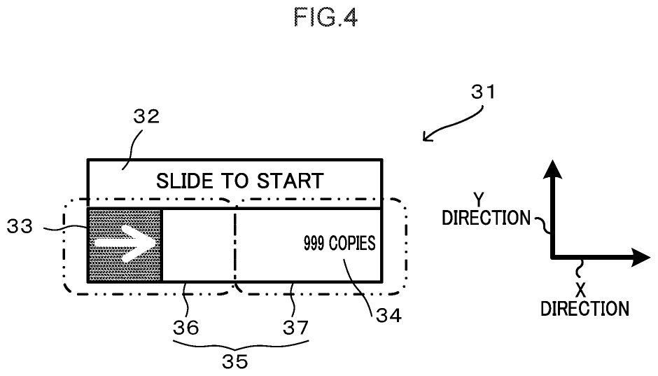

FIG. 4 is a diagram illustrating an example of the movable area 35 determined in advance for the instruction unit 31.

The instruction unit 31 includes a movable area 35 which is a movable area of the slide mark 33. The movable area 35 is an example of an area for determining non-execution of copying, execution of copying, and stopping of execution of copying in accordance with a position of the movably displayed slide mark 33. The movable area 35 includes a start area 36 and an execution area 37. The start area 36 is an area where a predetermined operation is not executed, and the execution area 37 is an area where a predetermined operation is executed. The predetermined operation described herein is, for example, an operation for giving an instruction to execute copying. In the example of FIG. 4, the message area 32 and the movable area 35 are included in the area indicating the instruction unit 31. In a case in which the message area 32 is not included in the area indicating the instruction unit 31, the entire area of the instruction unit 31 is the movable area 35.

Specifically, the execution area 37 is an area where the fact that execution of copying is executed is specified in a case in which there is the slide mark 33 at the time of completion of the movement operation in the area. The start area 36 is an area where the fact that copying is not executed (unexecuted) is specified in a case where the slide mark 33 at the time of completion of the movement operation is in the area.

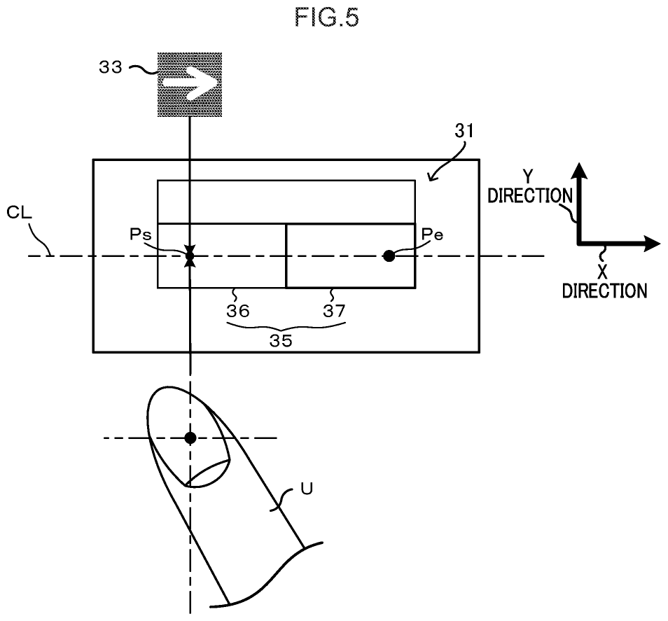

FIG. 5 is a schematic diagram illustrating an example of the relationship between the user operation and the position of the slide mark 33 with respect to the user operation in the instruction unit 31 displayed on the display unit 16.

The user U gives an instruction to execute copying while touching the slide mark 33 displayed on the instruction unit 31 of the display unit 16 with a finger of the user U and touching the slide mark 33 with the finger of the user U. The slide mark 33 is moved within the range in the X direction of the start area 36 and the execution area 37 on a line CL connecting the central positions in the Y direction of the start area 36 and the execution area 37. More specifically, in the slide mark 33, an initial position Ps which is a start point and an execution position Pe which is an end point are determined in advance, and can be displayed between the initial position Ps and the execution position Pe.

That is, the movement of the finger of the user U is a two-dimensional movement in the X direction and the Y direction. That is, the finger of the user U may be moved in an oblique direction. On the other hand, the movement of the slide mark 33 is a movement only in the movable area 35 in response to a movement operation by the user U, and the movement direction is limited to the X direction (or the opposite direction). The movement of the slide mark 33 is a one-dimensional movement. When the trajectory of the movement operation by the user U reaches outside of the instruction unit 31, the slide mark 33 moves into the movable area 35 following the movement operation by the user. That is, there is a projective relationship between the position of the finger of the user U and the position of the slide mark 33.

For example, when the center of the slide mark 33 in the X direction is located on the side of the start area 36, it is determined that the slide mark is located in the start area 36. When the center of the slide mark 33 in the X direction is located on the side of the execution area 37, it is determined that the slide mark 33 is located in the execution area 37. A boundary between the start area 36 and the execution area 37 can be appropriately set by the user.

In the examples of FIGS. 3 to 5, the instruction unit 31 is disposed laterally, but a disposition direction is not limited thereto. For example, the instruction unit 31 may be disposed vertically. In this case, the movement direction of the slide mark 33 is limited to the Y direction (or the opposite direction).

Meanwhile, in the instruction unit 31, in a case in which the user performs a movement operation on the slide mark 33 and the slide mark 33 moves over the start area 36 into the execution area 37, a predetermined operation (for example, an instruction to execute copying) is executed.

However, there may be a case in which the user wants to stop executing the operation during the movement operation and completes the movement operation outside of the instruction unit 31 of the slide mark 33. At this time, when the slide mark 33 is located in the execution area 37, the operation is executed without being stopped. That is, an unintended operation of the user may be executed.

On the other hand, the image forming device 10 according to the present embodiment includes the following control unit 11B and the operation control unit 11C illustrated in FIG. 2 described above.

As an example, the following control unit 11B detects an operation position (for example, coordinates) touched with a finger of the user U on the screen 30 illustrated in FIG. 3 described above. A stylus pen or the like may be used instead of the finger of the user U. As described above, the movement operation here is, for example, an operation such as dragging or sliding. A trajectory of the movement operation is derived from a plurality of positions continuously detected by the movement operation. In a case in which the touch of the slide mark 33 with the finger of the user U is detected, the following control unit 11B derives a position of the slide mark 33 caused to follow the movement operation with the finger of the user U.

The operation control unit 11C controls a predetermined operation (hereinafter referred to as a “copying instruction operation” as an example.) based on the operation position with the user U and the position of the slide mark 33. Specifically, when the user U performs the movement operation on the slide mark 33 and the trajectory of the movement operation reaches outside of the instruction unit 31, the operation control unit 11C moves the slide mark 33 to follow the movement operation into the movable area 35. The operation control unit 11C executes a copying instruction operation in a case in which the movement operation is completed inside the instruction unit 31 after the slide mark 33 is moved from the start area 36 into the execution area 37 by the movement operation (hereinafter referred to as a “first operation execution process”). The operation control unit 11C stops executing the copying instruction operation in a case in which the movement operation is completed outside of the instruction unit 31 after the slide mark 33 is moved from the start area 36 into the execution area 37 by the movement operation (hereinafter referred to as a “first operation stopping process”). In a case of a configuration in which the message area 32 is not included in the instruction unit 31, outside of the instruction unit 31 and outside of the movable area 35 are homonymous.

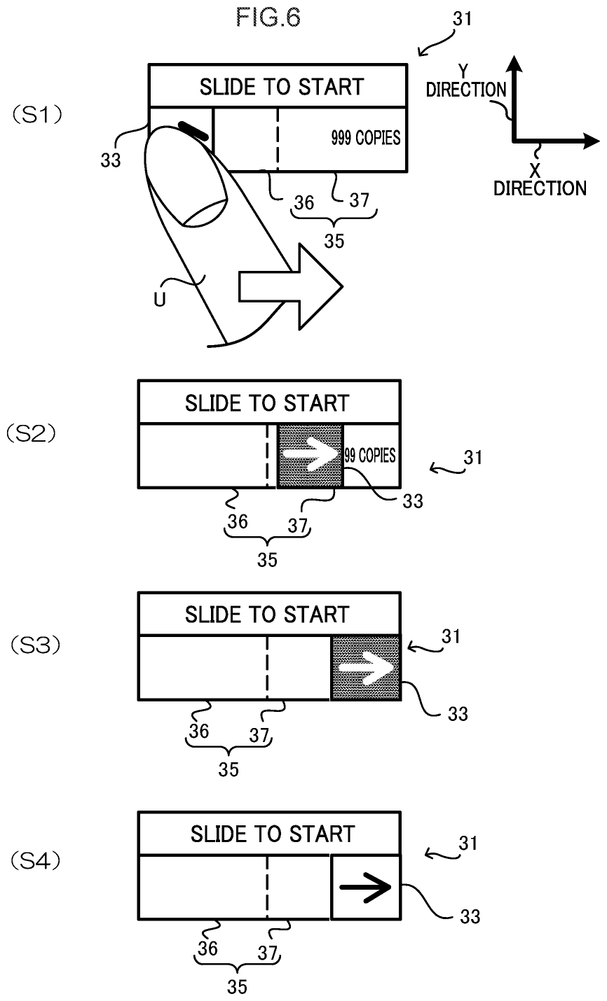

Next, the first operation execution process according to the first embodiment will be specifically described with reference to FIG. 6.

FIG. 6 is a diagram illustrating the first operation execution process according to the first embodiment.

In (step S1), when the slide mark 33 is touched with the finger of the user U, the CPU 11 detects the position of the slide mark 33 and changes the color of the slide mark 33 to a color indicating an operation execution reservation. Then, the slide mark 33 is moved in an arrow direction (X direction) to follow the movement operation by the user U. In the initial state, the slide mark 33 is located at a start end (here, a left end) of the start area 36. When the finger of the user U is released in a state where the slide mark 33 is separated from the start end and is located in the start area 36, it is determined that the movement operation is completed, and the slide mark 33 is returned to the start end, that is, attracted to the start end, and the copying instruction operation is not executed.

In (step S2), when the slide mark 33 is further moved in the X direction to follow the movement operation by the user U, the CPU 11 detects that the slide mark 33 has be moved over the start area 36 and reached the inside of the execution area 37. At this time, text (for example, 999 copies) of a portion through which the slide mark 33 passes enters non-display.

In (step S3), when the slide mark 33 is further moved in the X direction to follow the movement operation by the user U, the CPU 11 detects that the slide mark 33 has reached the end edge (here, the right end) of the execution area 37. Here, when the finger of the user U is detached, it is determined that the movement operation has been completed. When the finger of the user U is released in a state where the slide mark 33 is located in the execution area 37 and has not reached the end edge, it is determined that the movement operation is completed, and the slide mark 33 is moved to the end edge, that is, attracted to the end edge, as described above.

In (step S4), the CPU 11 executes the copying instruction operation and changes the color of the slide mark 33 moved to the end edge of the execution area 37 to a color indicating the execution of the operation. The execution of the copying instruction operation is started when the slide mark 33 is moved to the end edge of the execution area 37.

In this case, the CPU 11 serving as the operation control unit 11C moves the slide mark 33 from the start area 36 into the execution area 37 to follow the movement operation by the user U, and further executes the copying instruction operation when it is detected that the movement operation is completed inside the instruction unit 31.

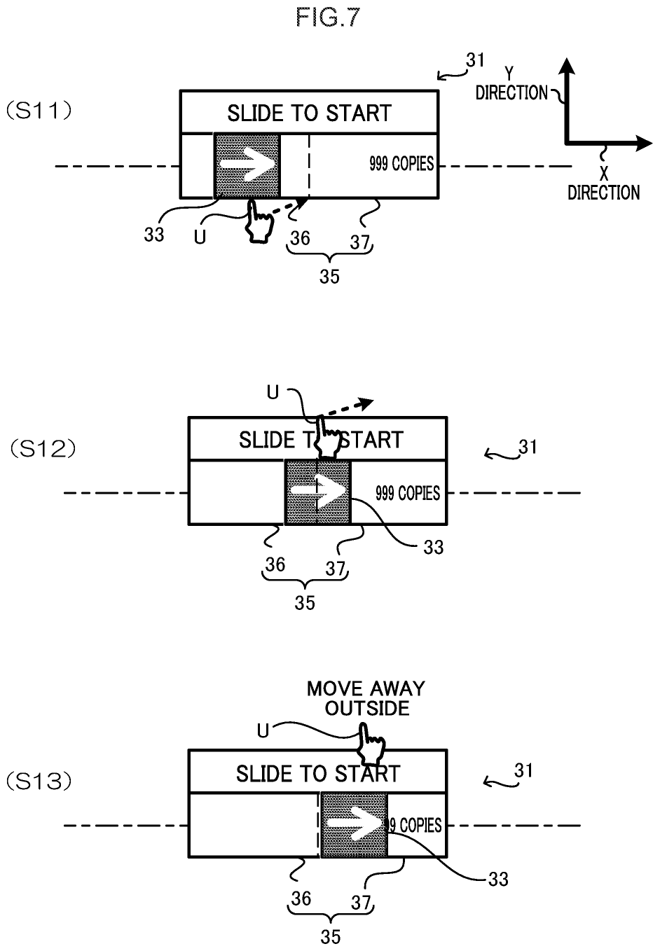

Next, the first operation stopping process according to the first embodiment will be specifically described with reference to FIG. 7.

FIG. 7 is a diagram illustrating the first operation stopping process according to the first embodiment.

In (step S11), the CPU 11 moves the slide mark 33 in the X direction to follow the movement operation of moving the finger of the user U in the direction of the dotted arrow (an obliquely upward direction).

In (step S12), when the slide mark 33 is further moved in the X direction to follow the movement operation in the obliquely upward direction by the user U, the CPU 11 detects that the slide mark 33 has been moved over the start area 36 and reached the inside of the execution area 37.

In (step S13), when the finger of the user U moves away outside of the instruction unit 31 in a state where the slide mark 33 is located in the execution area 37, the CPU 11 determines that the movement operation has been completed and stops executing the copying instruction operation. At this time, the slide mark 33 is moved to the start end of the start area 36, that is, attracted to the start end.

In this case, the CPU 11 serving as the operation control unit 11C moves the slide mark 33 from the start area 36 into the execution area 37 to follow the movement operation by the user U and further stops the execution of the copying instruction operation when it is detected that the movement operation is completed outside of the instruction unit 31. Therefore, execution of an unintended operation of the user is prevented.

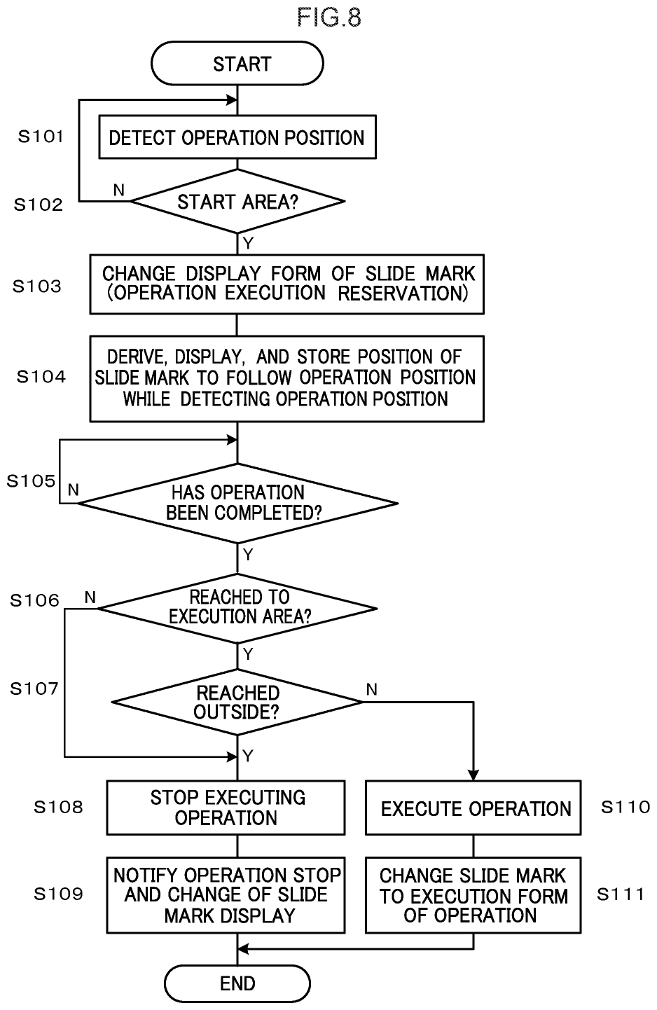

Next, an operational effect of the image forming device 10 according to the first embodiment will be described with reference to FIG. 8.

FIG. 8 is a flowchart illustrating an example of a flow of a process by the information processing program 15A according to the first embodiment.

First, as an example, when an instruction to execute display of the screen 30 illustrated in FIG. 3 is given to the image forming device 10, the information processing program 15A is started to execute the following steps.

In step S101 of FIG. 8, as an example, the CPU 11 detects an operation position touched with the finger of the user U on the above-described screen 30 illustrated in FIG. 3.

In step S102, the CPU 11 determines whether or not the operation position detected in step S101 is within the start area 36. In a case in which it is determined that the operation position is within the start area 36 (in the case of positive determination), the process proceeds to step S103. In case in which it is determined that the operation position is not within the start area 36 (in the case of negative determination), the process returns to step S101 and enters a standby state.

In step S103, the CPU 11 changes the display form of the slide mark 33 inside the start area 36 to a display form indicating the operation execution reservation (for example, the color is changed.).

In step S104, the CPU 11 derives the position of the slide mark 33 to follow the operation position while detecting the operation position with the finger of the user U, and displays and stores a derivation result.

In step S105, the CPU 11 determines whether or not the movement operation by the user U has been completed. In the determination of the completion of the movement operation, it is determined that the movement operation has been completed when the finger of the user U is moved away from the slide mark 33 (including releasing of a following relationship between the finger of the user U and the slide mark 33). In a case in which it is determined that the movement operation has been completed (in the case of positive determination), the process proceeds to step S106. In a case in which it is determined that the movement operation has not been completed (in the case of negative determination), standby is set in step S105.

In step S106, the CPU 11 determines whether or not the position of the slide mark 33 when the movement operation by the user U is completed in step S105 has reached the execution area 37. In a case in which it is determined that the position of the slide mark 33 has reached the inside of the execution area 37 (in the case of positive determination), the process proceeds to step S107. In a case in which it is determined that the position of the slide mark 33 has not reached the inside of the execution area 37 (in the case of positive determination), the process proceeds to step S108.

In step S107, the CPU 11 determines whether or not the trajectory of the movement operation by the user U has reached outside of the instruction unit 31, that is, whether or not the movement operation by the user U determined to be completed in step S105 has been completed outside of the instruction unit 31. In a case in which it is determined that the trajectory of the movement operation by the user U has reached outside of the instruction unit 31 (in the case of positive determination), the process proceeds to step S108. In a case in which it is determined that the trajectory of the movement operation by the user U has not reached outside of the instruction unit 31 (in the case of negative determination), the process proceeds to step S110.

In step S108, the CPU 11 stops executing the copying instruction operation which is an example of the predetermined operation.

In step S109, in order to notify that the execution of the copying instruction operation has been stopped, the CPU 11 changes the display form of the slide mark 33 (for example, the color is changed.), for example, and ends the series of processes by the information processing program 15A.

Conversely, in step S110, the CPU 11 executes the copying instruction operation.

In step S111, the CPU 11 changes the display form of the slide mark 33 in the execution area 37 to the display form indicating the execution of the operation (for example, the color is changed), and ends the series of processes by the information processing program 15A.

As described above, according to the present embodiment, in a case in which the slide mark reaches the execution area by the movement operation by the user and the movement operation is completed outside of the instruction unit, execution of an unintended operation is prevented.

### Second Embodiment

In the second embodiment, a mode will be described in which a predetermined operation is executed in a case in which the position of the slide mark is within the execution area when the movement operation is completed inside the instruction unit after the trajectory of the movement operation by the user reaches outside of the instruction unit.

Since the constituent elements included in the image forming device according to the present embodiment are the same as the constituent elements included in the image forming device 10 illustrated in FIGS. 1 and 2 described above, repeated description thereof will be omitted here.

In a case in which the movement operation is completed inside the instruction unit 31 after the trajectory of the movement operation by the user U reaches outside of the instruction unit 31, and the position of the slide mark 33 when the movement operation is completed inside the instruction unit is within the execution area 37, the CPU 11 serving as the operation control unit 11C according to the present embodiment executes a copying instruction operation which is an example of a predetermined operation (hereinafter referred to as a “second operation execution process”).

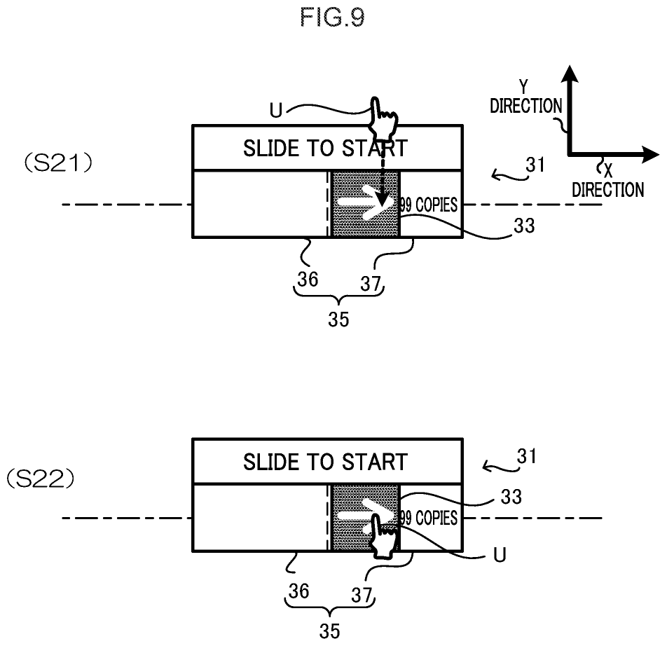

FIG. 9 is a diagram illustrating the second operation execution process according to the second embodiment.

In (step S21), the CPU 11 detects that the movement operation is completed inside the instruction unit 31 after the trajectory of the movement operation by the user U reaches outside of the instruction unit 31.

In (step S22), the CPU 11 detects that the position of the slide mark 33 when the movement operation by the user U is completed inside the instruction unit 31 is within the execution area 37. In this case, the CPU 11 executes the copying instruction operation.

The CPU 11 serving as the operation control unit 11C according to the present embodiment stops executing the copy instruction operation which is an example of the predetermined operation in a case in which the movement operation is completed inside the instruction unit 31 after the trajectory of the movement operation by the user reaches outside of the instruction unit 31 and the position of the slide mark 33 when the movement operation is completed inside the instruction unit is within the start area 36 (hereinafter referred to as a “second operation stopping process”).

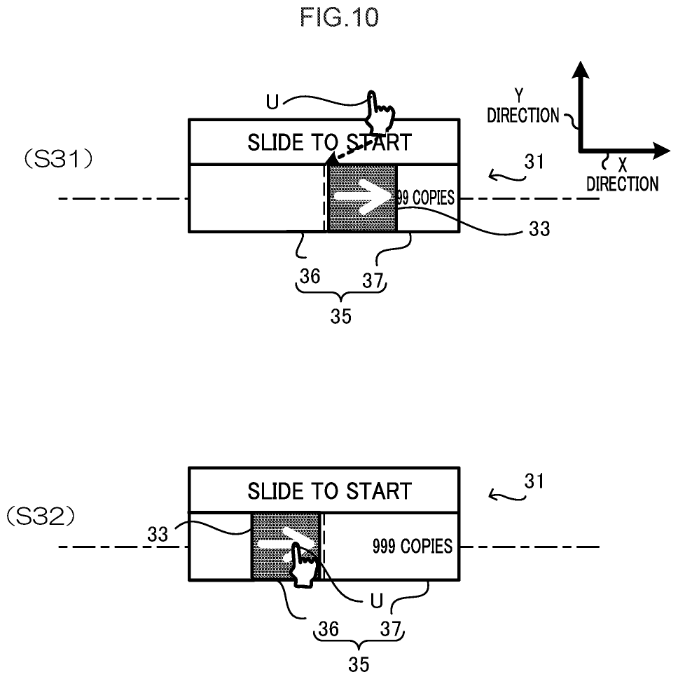

FIG. 10 is a diagram illustrating the second operation stopping process according to the second embodiment.

In (step S31), the CPU 11 detects that the movement operation is completed inside the instruction unit 31 after the trajectory of the movement operation by the user U reaches outside of the instruction unit 31.

In (step S32), the CPU 11 detects that the position of the slide mark 33 when the movement operation by the user U is completed inside the instruction unit 31 is within the start area 36. In this case, the CPU 11 stops executing the copying instruction operation.

In this way, according to the present embodiment, even in the case in which the trajectory of the movement operation by the user reaches outside of the instruction unit, the operation is executed by completing the movement operation in the execution area, and the execution of the operation is stopped by completing the movement operation in the start area.

### Third Embodiment

In a third embodiment, a mode will be described in which a predetermined operation is executed in a case in which an end point of the trajectory of the movement operation when the movement operation by the user is completed outside of the instruction unit is included in the area located in the movement direction of the slide mark.

Since the constituent elements included in the image forming device according to the present embodiment are the same as the constituent elements included in the image forming device 10 illustrated in FIGS. 1 and 2 described above, repeated description thereof will be omitted here.

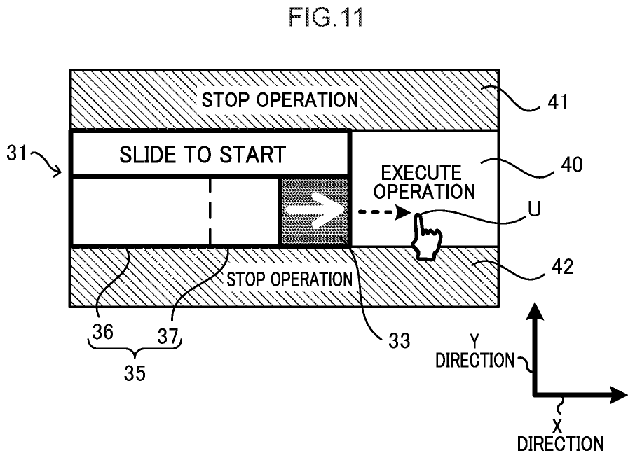

FIG. 11 is a diagram illustrating an example of a peripheral area of the instruction unit 31 according to the third embodiment.

As illustrated in FIG. 11, a first area 40, a second area 41, and a third area 42 are defined around instruction unit 31.

The first area 40 is an area located in the movement direction (the X direction) of the slide mark 33 in the movable area 35 of the slide mark 33 and is an area where a predetermined operation is executed. The second area 41 is an area located above the instruction unit 31 and the first area 40, and the third area 42 is an area located below the instruction unit 31 and the first area 40.

The CPU 11 serving as the operation control unit 11C according to the present embodiment executes a copying instruction operation which is an example of a predetermined operation in a case in which the movement operation is completed outside of the instruction unit 31 after the slide mark 33 is moved from the start area 36 into the execution area 37 by the movement operation by the user U and the end point of the trajectory of the movement operation when the movement operation is completed outside of the instruction unit is included in the first area 40. The end point of the trajectory here is indicated by the end point of a dotted arrow.

The CPU 11 serving as the operation control unit 11C stops executing the copy instruction operation when the movement operation when the movement operation is completed outside of the instruction unit 31 after the slide mark 33 is moved from the start area 36 into the execution area 37 by the movement operation by the user U and the end point of the trajectory of when the movement operation is completed outside of the instruction unit is not included in the first area 40, that is, included in the second area 41 or the third area 42.

In this way, according to the present embodiment, the predetermined operation is executed even in a case in which the position at which the user's finger is released is moved over from the execution area in order for the user to execute the predetermined operation.

### Fourth Embodiment

In a fourth embodiment, a mode will be described in which, when the trajectory of the movement operation by the user reaches outside of the instruction unit, it is notified that execution of a predetermined operation is stopped.

Since the constituent elements included in the image forming device according to the present embodiment are the same as the constituent elements included in the image forming device 10 illustrated in FIGS. 1 and 2 described above, repeated description thereof will be omitted here.

In a case in which the trajectory of the movement operation reaches outside of the instruction unit 31 after the slide mark 33 is moved from the start area 36 into the execution area 37 by the movement operation by the user U, the CPU 11 serving as the operation control unit 11C according to the present embodiment performs control such that it is notified that the execution of the copying instruction operation which is an example of the predetermined operation is stopped (hereinafter referred to as a “first notification process”).

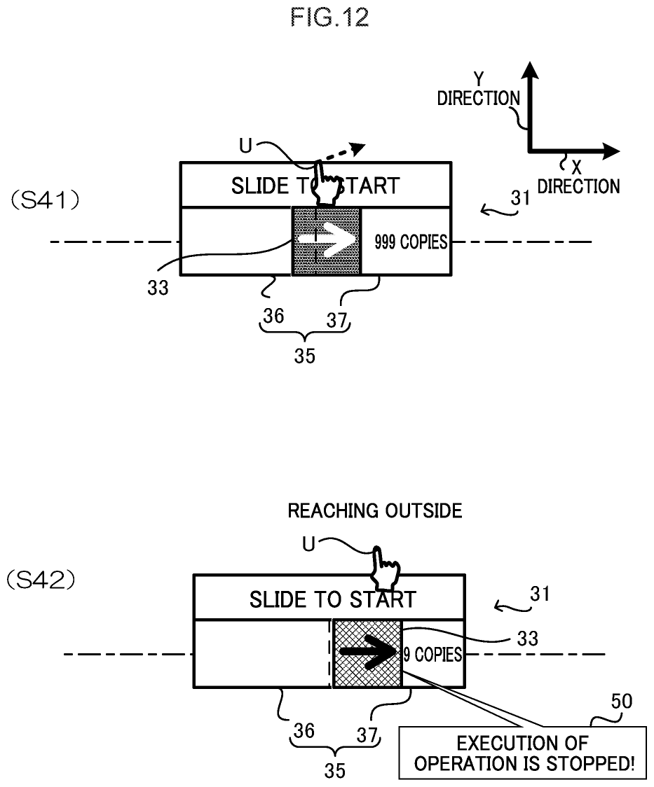

FIG. 12 is a diagram illustrating a first notification process according to the fourth embodiment.

In (step S41), the CPU 11 moves the slide mark 33 from the start area 36 into the execution area 37 to follow the movement operation by the user U.

In (step S42), the CPU 11 detects that the trajectory of the movement operation by the user U has reached outside of the instruction unit 31 and performs control such that it is notified that the execution of the copying instruction operation is stopped. As a method of the notification, for example, a method of changing the color of the slide mark 33 is changed and displaying a message 50 indicating stop of the execution of the operation, or the like is executed This notification is performed at a time point at which the trajectory of the movement operation by the user U reaches outside of the instruction unit 31. Even in a case in which the finger of the user U moves away outside of the instruction unit 31 and the movement operation is completed, the notification continues for a certain period of time.

In this way, according to the present embodiment, in a case in which the trajectory of the movement operation by the user reaches outside of the instruction unit, it is notified that the execution of the predetermined operation is stopped. Therefore, the user ascertains that the operation is stopped.

### Fifth Embodiment

In a fifth embodiment, a mode will be described in which, when the trajectory of the movement operation by the user reaches outside of the instruction unit, it is notified that the execution of the predetermined operation is stopped by changing the background color of the movable area.

Since the constituent elements included in the image forming device according to the present embodiment are the same as the constituent elements included in the image forming device 10 illustrated in FIGS. 1 and 2 described above, repeated description thereof will be omitted here.

The background color of the movable area 35 is different between a case in which the slide mark 33 is located in the start area 36 and a case in which the slide mark 33 is located in the execution area 37. In a case in which the trajectory of the movement operation reaches outside of the instruction unit 31 after the slide mark 33 is moved from the start area 36 into the execution area 37 by the movement operation by the user U, the CPU 11 serving as the operation control unit 11C according to the present embodiment controls the background color of the movable area 35 such that the background color is the same as the background color in a case in which the slide mark 33 is located in the start area 36 (hereinafter referred to as a “second notification process”).

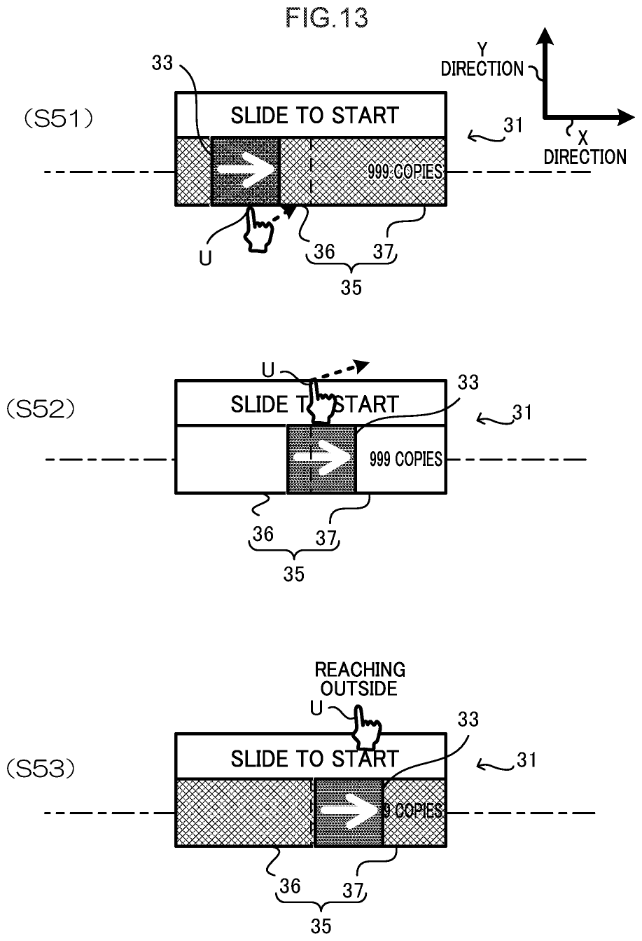

FIG. 13 is a diagram illustrating the second notification process according to the fifth embodiment.

In (step S51), the CPU 11 moves the slide mark 33 in the X direction to follow the movement operation of moving the finger of the user U in the direction of the dotted arrow (an obliquely upward direction). At this time, since the slide mark 33 is located in the start area 36, the background color of the movable area 35 is set to the first color.

In (step S52), when the CPU 11 further moves the slide mark 33 in the X direction to follow the movement operation in the obliquely upward direction by the user U, it is detected that the slide mark 33 has been moved over the start area 36 and reached the inside of the execution area 37. At this time, since the slide mark 33 is located in the execution area 37, the background color of the movable area 35 is set to a second color different from the first color.

In (step S53), in a case in which the finger of the user U reaches outside of the instruction unit 31 in a state in which the slide mark 33 is located in the execution area 37, the CPU 11 changes the background color of the movable area 35 to the first color. That is, since the trajectory of the movement operation by the user U reaches outside of the instruction unit 31 and the slide mark 33 is located in the execution area 37, the background color of the movable area 35 is set to the first color in order to notify that the copying instruction operation which is an example of the predetermined operation is stopped.

In this way, according to the present embodiment, in a case in which the trajectory of the movement operation by the user reaches outside of the instruction unit, it is notified that the execution of the predetermined operation is stopped by changing the background color of the movable area. Therefore, the user ascertains that the operation is stopped.

In the above embodiment, the processor is a processor in a broad sense and includes a general-purpose processor (for example, a central processing unit (CPU), and the like) or a dedicated processor (for example, a graphics processing unit (GPU), an application specific integrated circuit (ASIC), a field programmable gate array (FPGA), a programmable logic device, or the like).

In addition, the operation of the processor in the above-described embodiment may be executed not only by one processor but also by cooperation of a plurality of processors existing at physically separated positions. The order of operations of the processor is not limited to the order described in each of the above-described embodiments, and may be appropriately changed.

The image forming device has been described above as an example of the information processing device according to the embodiment. The embodiment may be in the form of a program causing a computer to execute a function of each unit included in the image forming device. The embodiment may be in the form of a non-transitory computer-readable storage medium that stores the program.

In addition, the configuration of the image forming device described in the above embodiment is an example and may be changed according to the situation without departing from the gist.

The flow of the process of the program described in the above embodiment is also an example, and unnecessary steps may be deleted, new steps may be added, or the processing order may be changed within a scope not departing from the gist.

In the above-described embodiment, a case in which the process according to the embodiment is implemented by a software configuration using a computer by executing a program has been described, but the present invention is not limited thereto. The embodiment may be implemented by, for example, a hardware configuration or a combination of a hardware configuration and a software configuration.

The disclosure of Japanese Patent Application No. 2020-200492 filed on Dec. 2, 2020 is incorporated herein by reference in its entirety. All documents, patent applications, and technical standards described in this specification are incorporated herein by reference to the same extent as if each document, patent application, and technical standard were specifically and individually indicated to be incorporated by reference.

1. An information processing device comprising a processor,
wherein, in a case in which a user performs a movement operation on an operation unit displayed on a display unit, and a trajectory of the movement operation reaches outside of an instruction unit including a movable area that is an area where the operation unit is movable, the processor causes the operation unit to move into the movable area and follow the movement operation,
wherein, in a case in which the movement operation is completed inside the instruction unit after the operation unit is moved by the movement operation from a start area which is an area included in the movable area and in which a predetermined operation is not executed into an execution area which is an area where the predetermined operation is executed, the processor executes the predetermined operation, and
wherein, in a case in which the movement operation is completed outside of the instruction unit after the operation unit is moved from the start area into the execution area by the movement operation, the processor stops executing the predetermined operation.

2. The information processing device according to claim 1,
wherein the processor executes the predetermined operation in a case in which the movement operation is completed inside the instruction unit and a position of the operation unit when the movement operation is completed inside the instruction unit is within the execution area after the trajectory of the movement operation reaches outside of the instruction unit.

3. The information processing device according to claim 1,
wherein the processor stops executing the predetermined operation in a case in which the movement operation is completed inside the instruction unit and the position of the operation unit when the movement operation is completed inside the instruction unit is within the start area after the trajectory of the movement operation reaches outside of the instruction unit.

4. The information processing device according to claim 1,
wherein in a case in which the movement operation is completed outside of the instruction unit after the operation unit is moved from the start area into the execution area by the movement operation, instead of stopping executing the predetermined operation, the processor moves the operation unit from the start area into the execution area by the movement operation and then completes the movement operation outside of the instruction unit,
wherein, in a case in which an end point of the trajectory of the movement operation when the movement operation is completed outside is included in an area located in a movement direction of the operation unit in the movable area, the processor executes the predetermined operation and completes the movement operation outside of the instruction unit after the operation unit is moved from the start area into the execution area by the movement operation, and
wherein, in a case in which the end point of the trajectory of the movement operation when the movement operation is completed outside is not included in the area located in the movement direction of the operation unit in the movable area, the processor stops executing the predetermined operation.

5. The information processing device according to claim 1,
wherein the processor performs control such that notification that the execution of the predetermined operation has stopped is executed when the trajectory of the movement operation reaches outside of the instruction unit after the operation unit is moved from the start area into the execution area by the movement operation.

6. The information processing device according to claim 5,
wherein a background color of the movable area is different between a case in which the operation unit is located inside the start area and a case in which the operation unit is located inside the execution area, and
wherein, in a case in which the trajectory of the movement operation reaches outside of the instruction unit after the operation unit is moved from the start area into the execution area by the movement operation, the processor executes control such that the background color of the movable area is identical to a background color in a case in which the operation unit is located in the start area.

7. A non-transitory computer-readable storage medium storing an information processing program causing a computer to execute processing comprising:
causing an operation unit to move into a movable area and follow a movement operation in a case in which a user performs the movement operation on the operation unit which is displayed on a display unit, and a trajectory of the movement operation reaches outside of an instruction unit including a movable area that is an area where the operation unit is movable;
executing a predetermined operation in a case in which the movement operation is completed inside the instruction unit after the operation unit is moved by the movement operation from a start area which is an area included in the movable area and in which the predetermined operation is not executed into an execution area which is an area where the predetermined operation is executed; and
stopping executing the predetermined operation in a case in which the movement operation is completed outside of the instruction unit after the operation unit is moved from the start area into the execution area by the movement operation.
